(19) United States
(12) Patent Application Publication
(10) Pub. No.: US 2024/0231190 A1
(43) Pub. Date: Jul. 11, 2024

(54) CAMERA MODULE

(71) Applicant: SAMSUNG ELECTRO-MECHANICS CO., LTD., Suwon-si (KR)

(72) Inventors: Do Seop HWANG, Suwon-si (KR); Chuel Jin PARK, Suwon-si (KR); Su Kyeong KIM, Suwon-si (KR); Je Ho KIM, Suwon-si (KR)

(73) Assignee: SAMSUNG ELECTRO-MECHANICS CO., LTD., Suwon-si (KR)

(21) Appl. No.: 18/503,725

(22) Filed: Nov. 7, 2023

(30) Foreign Application Priority Data
Jan. 5, 2023 (KR) 10-2023-0001897
Jun. 12, 2023 (KR) 10-2023-0075086
Sep. 12, 2023 (KR) 10-2023-0121310

(51) Int. Cl. G03B 13/36

(52) U.S. Cl. CPC G03B 13/36

(57) ABSTRACT

A camera module includes a lens unit including at least one lens, a first carrier configured to accommodate a portion of the lens unit and move in an optical axis direction, a second carrier configured to accommodate the first carrier and move in a direction perpendicular to the optical axis, and a connection substrate disposed to surround a side surface of the second carrier, wherein a first ball group and a second ball group spaced apart from each other in a direction perpendicular to the optical axis, are included between the first carrier and the second carrier, the number of balls of the first ball group is greater than the number of balls of the second ball group, and the connection substrate is disposed to surround the second carrier toward the second ball member.

### CROSS-REFERENCE TO RELATED APPLICATIONS

This application claims the benefit under 35 USC 119(a) of Korean Patent Application Nos. 10-2023-0001897 filed on Jan. 5, 2023, 10-2023-0075086 filed on Jun. 12, 2023, and 10-2023-0121310 filed on Sep. 12, 2023, in the Korean Intellectual Property Office, the entire disclosures of which are incorporated herein by reference for all purposes.

### BACKGROUND

### 1. Field

The present disclosure relates to a camera module.

### 2. Description of the Background

Camera modules may be standardly installed in portable electronic devices (mobile terminals) such as tablet personal computers (PCs), laptop computers, and the like, as well as in smartphones. An autofocusing (AF) function, an optical image stabilization (OIS) function, a zoom function, and the like, may be added to camera modules for mobile terminals.

However, in order for such camera modules to implement various functions, the size and weight of the camera module are bound to increase, which may again cause deterioration of the performance of the camera module. For example, the number of lenses installed in camera modules may be increasing; however, when performing a focusing function and/or optical image stabilization, the weight of a moving unit may increase, which may interfere with stable operations.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens unit including at least one lens, a first carrier configured to accommodate a portion of the lens unit and move in an optical axis direction, a second carrier configured to accommodate the first carrier and move in a direction perpendicular to the optical axis direction, and a connection substrate disposed to surround a side surface of the second carrier, wherein a first ball group and a second ball group spaced apart from each other in the direction perpendicular to the optical axis direction, are included between the first carrier and the second carrier, the number of balls of the first ball group is greater than the number of balls of the second ball group, and the connection substrate is disposed to surround the second carrier toward the second ball member.

The camera module may further include a housing configured to accommodate the second carrier, wherein the connection substrate may include a first substrate disposed in the second carrier, a connection portion disposed in the housing, and an extension portion connecting the first substrate and the connection portion, and having a curved shape at a portion thereof.

The extension portion may include a first portion disposed between one side surface of the second carrier and a side surface of the housing facing the one side surface of the second carrier, and a second portion disposed between the other side of the second carrier and a side of the housing facing the other side of the second carrier.

The housing may include a through-hole on a side surface on which the connection portion is disposed, and the second portion may be disposed to pass through the through-hole.

The camera module may further include a first magnet disposed on the first carrier between the first ball group and the second ball group, and a first coil mounted on the first substrate and facing the first magnet, wherein the first magnet and the first coil may form driving force for moving the first carrier in the optical axis direction.

The camera module may further include a second magnet and a third magnet disposed on two different side surfaces of the second carrier, respectively, and a second coil and a third coil mounted on the second substrate and disposed in the housing so as to face the second and third magnets, respectively, wherein the second and third magnets and the second coil and third coils may form driving force for moving the second carrier in a direction perpendicular to the optical axis.

The camera module may further include a frame disposed between the second carrier and the housing, a third ball group disposed between the second carrier and the frame, and configured to move in a rolling motion in a first axis direction perpendicular to the optical axis, and a fourth ball group disposed between the frame and the housing, and configured to move in a rolling motion in a second axis direction perpendicular to both the optical axis and the first axis.

The first carrier and the second carrier may include a plurality of guide grooves on surfaces facing each other with the first ball group and the second ball group interposed therebetween, and among the plurality of guide grooves, guide grooves facing each other with the second ball group interposed therebetween may have different cross-sectional shapes.

The lens unit may include a first lens unit coupled to the second carrier, and a second lens unit coupled to the first carrier and configured to move in the optical axis direction relative to the first lens unit.

The first lens unit may further include a lens stage fixedly coupled to an upper surface of the second carrier.

The camera module may further include a stopper disposed between the first lens unit and the second lens unit.

A portable electronic device may include the camera module and an image sensor configured to convert light passing through the at least one lens into an electrical signal.

In another general aspect, a camera module includes a lens unit including a first lens unit and a second lens unit disposed in an optical axis direction, a moving unit configured to accommodate the second lens unit and move in the optical axis direction, together with the second lens unit, and a fixed unit configured to accommodate the moving unit and not to move in the optical axis direction, wherein the first lens unit is coupled to the fixed unit and configured not to move in the optical axis direction.
the moving unit may include a first carrier, and the fixed unit may include a second carrier, and the first lens unit may be coupled to the second carrier, and may be moved in a direction perpendicular to the optical axis, together with the second carrier, the first carrier, and the second lens unit.

The camera module may further include a first magnet and a first coil configured to form driving force for moving the first carrier in the optical axis direction, a second magnet and a second coil configured to form driving force for moving the second carrier in a first axis direction perpendicular to the optical axis, and a third magnet and a third coil configured to form driving force for moving the second carrier in a second axis direction perpendicular to the optical axis and the first axis, wherein the first coil may be disposed in the second carrier, and the second and third coils may be disposed in the housing.

The camera module may further include a connection substrate connecting the second carrier and the housing, wherein the connection substrate may include a first substrate on which the first coil is disposed, a connection portion disposed in the housing, and an extension portion extending between the first substrate and the connection portion and configured to support a movement of the second carrier.

The extension portion may include a first portion supported by a side surface of the second carrier, and a second portion spaced apart from the second carrier and the housing.

The moving unit may include a first carrier, and the fixed unit may include a housing, and the first lens unit may be coupled to the housing.

A portable electronic device may include the camera module and an image sensor configured to convert light passing through the first lens unit and the second lens unit into an electrical signal.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is a schematic exploded perspective view of a camera module according to an example embodiment of the present disclosure.

FIG. 3 is a view illustrating a state in which a case is removed from FIG. 1.

FIG. 4 is a view illustrating a state in which a first lens unit is removed from FIG. 3.

FIG. 5 is an exploded perspective view of a carrier and a housing according to an example embodiment of the present disclosure.

FIG. 6 is an exploded perspective view of a second lens unit and a first carrier according to an example embodiment of the present disclosure.

FIG. 7 is an exploded perspective view of a first carrier and a second carrier according to an example embodiment of the present disclosure.

FIGS. 8A and 8B are views illustrating examples of optical axis direction distances between a first lens unit and a second lens unit before and after autofocus adjustment.

FIG. 9 is an exploded perspective view of a second carrier and a housing according to an example embodiment of the present disclosure.

FIGS. 10A and 10B are top and bottom perspective views of a ball guide according to an example embodiment of the present disclosure.

FIG. 11 is a perspective view illustrating a state in which a connection substrate is separated according to an example embodiment of the present disclosure.

FIG. 12 is an exploded perspective view of a second carrier and a housing on which a connection substrate is mounted according to an example embodiment of the present disclosure.

FIG. 13 is a view of the second carrier of FIG. 12 when viewed from a different direction.

FIG. 14 is a perspective view of a camera module according to another example embodiment of the present disclosure.

FIG. 15 is a schematic exploded perspective view of a camera module according to another example embodiment of the present disclosure.

FIGS. 16A and 16B are views illustrating examples of optical axis direction distances between a first lens unit and a second lens unit before and after autofocus adjustment.

FIG. 17 is a perspective view of a portable electronic device according to an example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Furthermore, in this specification, an optical axis direction may refer to a direction extending up and down an optical axis of a lens unit, i.e., a direction in parallel with the optical axis, a first axis direction may refer to a direction perpendicular to the optical axis direction, and a second axis direction may refer to a direction perpendicular to both the optical axis direction and the first axis direction.

An aspect of the present disclosure may provide a camera module having improved calibration performance during image capturing and a camera module having a super macro function.

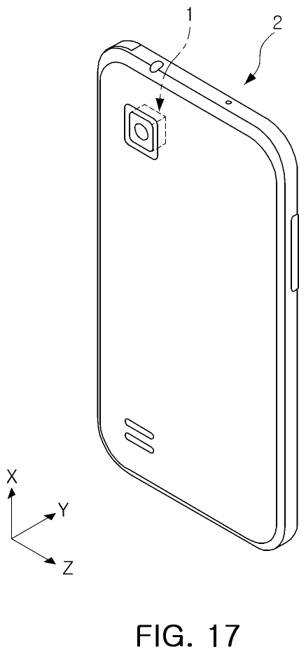

The present disclosure relates to a camera module 1 mounted in a portable electronic device 2 (FIG. 17). For example, portable electronic devices may be any type of portable electronic device, such as a smartphone, a tablet PC, or a laptop computer.

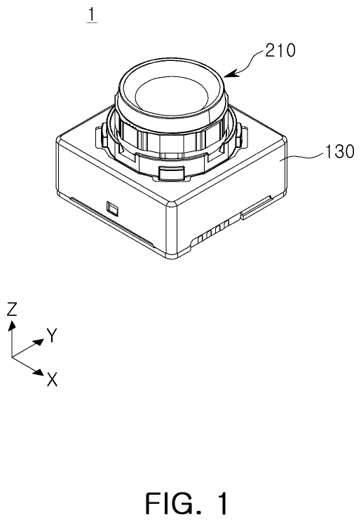

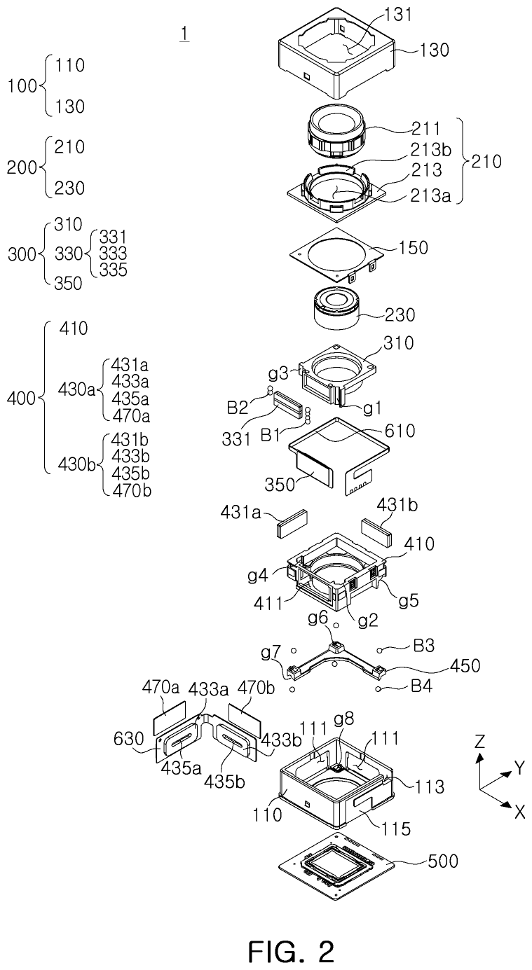

FIG. 1 is a perspective view of a camera module according to an example embodiment of the present disclosure, and FIG. 2 is a schematic exploded perspective view of a camera module according to an example embodiment of the present disclosure.

Referring to FIGS. 1 and 2, the camera module 1 according to an example embodiment of the present disclosure may include a housing unit 100, a lens unit 200, a focus adjustment unit 300, a shaking correcting unit 400, and an image sensor unit 500.

The housing unit 100 may include a housing 110 having an internal space and a case 130 coupled to the housing 110 to cover the internal space.

The housing 110 may be provided in a shape of a square box in which an upper portion and a lower portion thereof are open, and may have an internal space.

The lens unit 200, the focus adjustment unit 300, and the shaking correcting unit 400 may be accommodated in the internal space of the housing 110. In an example embodiment, the lens unit 200, focus adjustment unit 300, and shaking correcting unit 400 may be accommodated in the internal space of the housing 110 in order in the optical axis direction (Z-axis direction), and a portion of the lens unit 200 may protrude outside of the case 130. The case 130 may include an opening 131 in which the lens unit 200 protruding to the outside is disposed.

The image sensor unit 500 may be coupled to a lower surface of the housing 110.

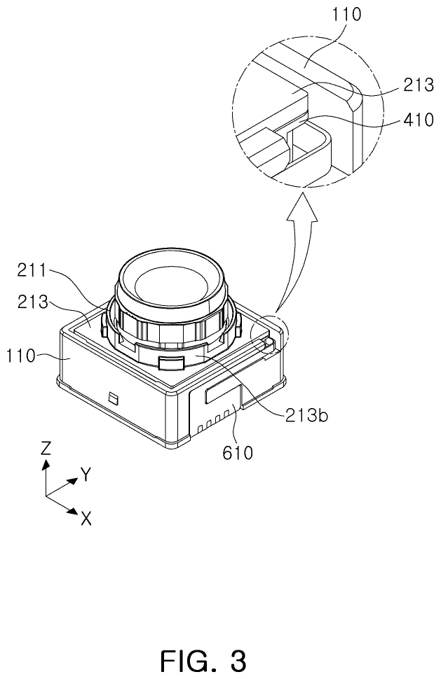

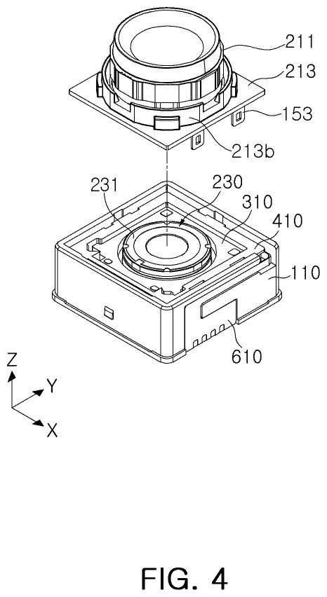

FIG. 3 is a view illustrating a state in which a case is removed from FIG. 1, and FIG. 4 is a view illustrating a state in which a first lens unit is removed from FIG. 3.

Referring to FIGS. 2 to 4, a lens unit 200 may include a first lens unit 210 and a second lens unit 230 disposed in the optical axis direction (Z-axis direction). For example, the first lens unit 210 may be disposed on an upper side of the second lens unit 230 and may be also disposed in the opening 131 of the case 130.

The first lens unit 210 may include a first lens barrel 211, and the second lens unit 230 may include a second lens barrel 231. At least one lens may be mounted inside the first and second lens barrels 211 and 231 in the optical axis direction (Z-axis direction).

The first lens unit 210 may further include a lens stage 213 to which the first lens barrel 211 is coupled.

The lens stage 213 may have a square plate shape including an opening 213a. The first lens barrel 211 may be disposed in the opening 213a. Furthermore, the lens stage 213 may include a guide protrusion 213b protruding in the optical axis direction (Z-axis direction) along a circumference of the opening 213a. The guide protrusion 213b may guide a coupling position of the first lens barrel 211 so that a central portion of the first lens barrel 211 is disposed on an optical axis (Z-axis) (or coincides with a central portion of the second lens barrel 231).

According to an example embodiment of the present disclosure, the second lens unit 230 may be configured to relatively move in the optical axis direction (Z-axis direction) with respect to the first lens unit 210. Referring to FIG. 4, the second lens unit 230 may be accommodated in a first carrier 310 described below, and may be moved in the optical axis direction (Z-axis direction) together with the first carrier 310 during focus adjustment. On the other hand, referring to FIG. 3, since the first lens unit 210 is coupled to a second carrier 410 described below (in detail, the lens stage 213 of the first lens unit 210 is coupled to an upper surface of the second carrier 410), the first lens unit 210 may not be moved in the optical axis direction (Z-axis direction).

That is, according to an example embodiment of the present disclosure, during the focus adjustment, a relative position of the second lens unit 230 in the optical axis direction (Z-axis direction) with respect to the first lens unit 210 may be changed, thereby implementing a super macro function.

In the above-described example embodiment, since the first lens unit 210 is coupled to the second carrier 410, the first lens unit 210 may move in directions (X-axis and Y-axis directions) perpendicular to the optical axis, together with the second carrier 410 during shaking correction. Meanwhile, referring to FIG. 4, the first carrier 310 may be accommodated in the second carrier 410, and accordingly, the first carrier 310 and the second lens unit 230 accommodated in the first carrier 310 may also be moved in directions (X-axis and Y-axis directions) perpendicular to the optical axis, together with the second carrier 410. Accordingly, during the shaking correction, the first lens unit 210 and the second lens unit 230 may be moved together in directions (X-axis and Y-axis directions) perpendicular to the optical axis.

Referring to FIG. 2, a stopper 150 may be disposed between the first lens unit 210 and the second lens unit 230.

The stopper 150 may serve to regulate a movement range of the first carrier 310 in the optical axis direction (Z-axis direction) and alleviating impacts caused by collisions between components.

The stopper 150 may be coupled to the second carrier 410 to cover an upper surface of the first carrier 310. Furthermore, although not illustrated in the drawing, the stopper 150 may include a buffer member on a surface oriented toward the first carrier 310 (i.e., a lower surface of the stopper 150 based on the drawing).

The image sensor unit 500 may include an image sensor and a sensor substrate on which the image sensor is disposed.

The image sensor may be disposed on the sensor substrate so that a central portion thereof coincides with the optical axis (Z-axis) of a plurality of lenses constituting the lens unit 200.

The image sensor may convert light passing through the plurality of lenses into an electrical signal. For example, the image sensor may be a charge coupled device (CCD) or a complementary metal-oxide semiconductor (CMOS).

The image sensor unit 500 may further include an infrared blocking filter disposed between the lens unit 200 and the image sensor. The infrared blocking filter may block light in an infrared region among light which passes through the lens unit 200 and is incident on the image sensor.

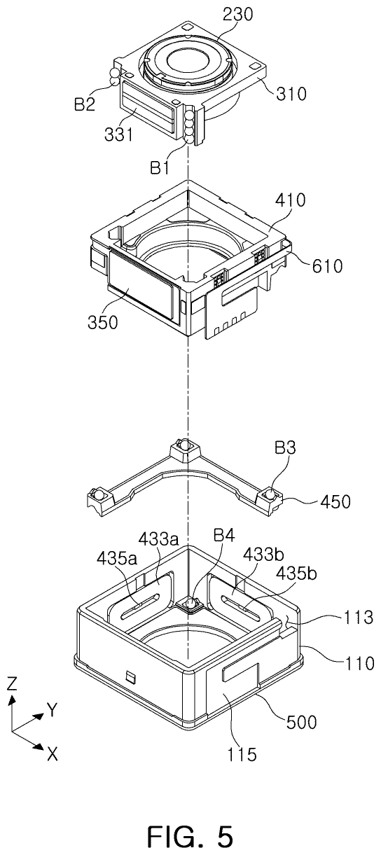

FIG. 5 is an exploded perspective view of a carrier and a housing according to an example embodiment of the present disclosure.

A camera module 1 according to an example embodiment of the present disclosure may include a focus adjustment unit 300 for moving a portion of a lens unit 200 (the second lens unit 230) in the optical axis direction (Z-axis direction), and a shaking correcting unit 400 for moving the lens unit 200 (i.e., the first lens unit 210 and the second lens unit 230) in directions (X-axis and Y-axis directions) perpendicular to the optical axis.

Referring to FIG. 5, the focus adjustment unit 300 and the shaking correcting unit 400 may be accommodated in an internal space of a housing 110 in order in the optical axis direction (Z-axis direction). That is, according to an example embodiment of the present disclosure, the focus adjustment unit 300 may be accommodated in the shaking correcting unit 400, and a structure in which the focus adjustment unit 300 is accommodated in the shaking correcting unit 400 may be advantageous for stable operations because a weight of a portion moved in the optical axis direction (Z-axis direction) is relatively light during the focus adjustment.

Furthermore, according to an example embodiment of the present disclosure, as described above, because only a portion of the lens unit 200 (the second lens unit 230) is moved in the optical axis direction (Z-axis direction), the weight of the portion moved during the focus adjustment may be further reduced.

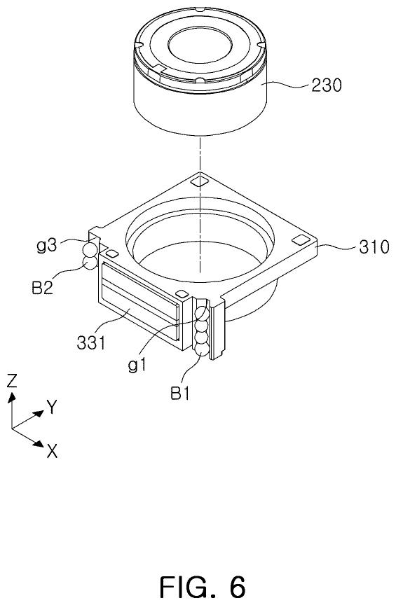

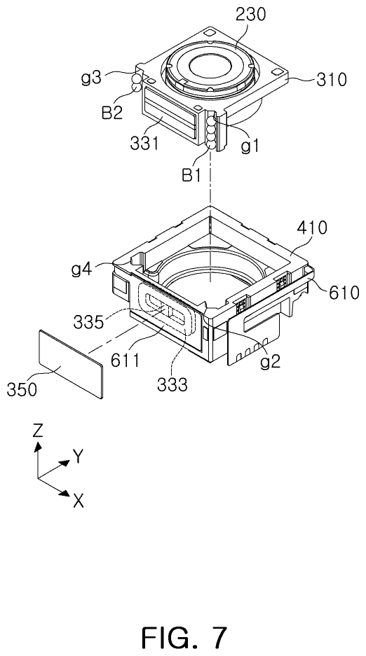

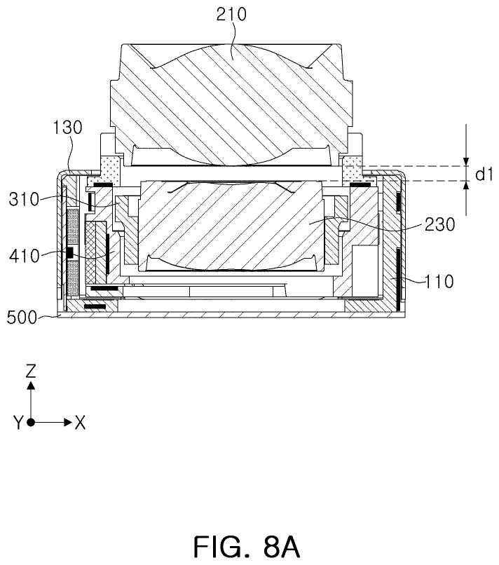

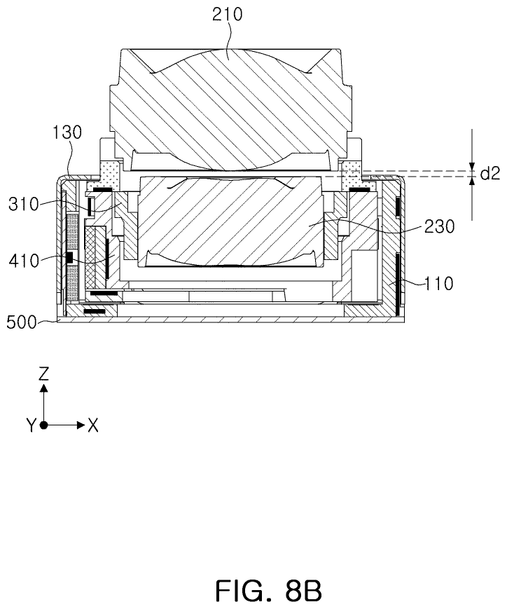

FIG. 6 is an exploded perspective view of a second lens unit and a first carrier according to an example embodiment of the present disclosure, FIG. 7 is an exploded perspective view of a first carrier and a second carrier according to an example embodiment of the present disclosure, and FIGS. 8A and 8B are views illustrating example optical axis direction distances between a first lens unit and a second lens unit before and after autofocus adjustment;

The focus adjustment unit 300 may include a first carrier 310 for accommodating the second lens unit 230 and a first driver 330 for generating driving force to move the first carrier 310 in the optical axis direction (Z-axis direction).

The second lens unit 230 may be moved in the optical axis direction (Z-axis direction) together with the first carrier 310 by the driving force generated by the first driver 330. In this process, a distance in the optical axis direction (Z-axis direction) between the second lens unit 230 and the image sensor may be changed.

Furthermore, as the second lens unit 230 moves in the optical axis direction (Z-axis direction), distances d1 and d2 in the optical axis direction (Z-axis direction) between the second lens unit 230 and the first lens unit 210 may also be changed. As the second lens unit 230 moves to narrow the distance from the first lens unit 210, a super macro function may be implemented.

The first driver 330 may include a first magnet 331 and a first coil 333.

The first magnet 331 and the first coil 333 may be disposed separately in the first carrier 310 and the second carrier 410. For example, the first magnet 331 may be disposed in one side surface of the first carrier 310, and the first coil 333 may be disposed in one side surface of the second carrier 410 oriented toward the one side surface of the first carrier 310. Accordingly, the first magnet 331 and the first coil 333 may face each other in a direction (Y-axis direction in the drawing) perpendicular to an optical axis.

A back yoke (not illustrated) may be disposed between the first magnet 331 and the first carrier 310. For example, the back yoke may be inserted into the first carrier 310 so that at least a portion thereof is exposed to one side surface of the first carrier 310 in which the first magnet 331 is disposed. The back yoke may prevent leakage of magnetic flux by focusing magnetic force of the first magnet 331.

The first coil 333 may be disposed on one side surface of the second carrier 410 while being mounted on a first substrate 611. The second carrier 410 may include an opening 411 on one side surface in which the first substrate 611 is disposed, and the first coil 333 may face directly the first magnet 331 through the opening 411.

For example, a connection substrate 610 may be disposed outside the second carrier 410. Since at least a portion of the connection substrate 610 is formed of a flexible material, the connection substrate 610 may have a shape that entirely surrounds a side surface of the second carrier 410.

The first substrate 611 on which the first coil 333 is mounted may be a portion of the connection substrate 610. A detailed description of the connection substrate 610 will be described below.

When power is applied to the first coil 333, electromagnetic force may be formed between the first magnet 331 and the first coil 333, and the first carrier 310 and the second lens unit 230 may be moved in the optical axis direction (Z-axis direction) by the electromagnetic force.

Furthermore, the first magnet 331 disposed on the first carrier 310 may be moved in the optical axis direction (Z-axis direction) together with the first carrier 310. However, the first coil 333 disposed in the second carrier 410 may not be moved in the optical axis direction (Z-axis direction).

The first driver 330 may include a first position sensor 335 for sensing a position of the lens unit 200, specifically, the second lens unit 230, in the optical axis direction (Z-axis direction). For example, the first position sensor 335 may be a hall sensor.

The first position sensor 335 may be mounted on the first substrate 610 together with the first coil 333, and may face the first magnet 331 in a direction (Y-axis direction in the drawing) perpendicular to the optical axis.

A plurality of ball members for guiding a movement of the first carrier 310 in the optical axis direction (Z-axis direction) may be disposed between the first carrier 310 and the second carrier 410.

The plurality of ball members includes a first ball group B1 and a second ball group B2 comprised of one or more balls (spheres), preferably a plurality of balls (spheres) disposed in the optical axis direction (Z-axis direction).

The first ball group B1 and the second ball group B2 may be spaced apart from each other in a direction (X-axis direction in the drawing) perpendicular to the optical axis. For example, the first ball group B1 and the second ball group B2 may be disposed on both sides of the first magnet 331 in a longitudinal direction, respectively.

The first carrier 310 may include a first guide groove g1 and a third guide groove g3 extending in a direction in parallel with the optical axis (Z-axis) on both sides of the first magnet 331 in the longitudinal direction, respectively.

The second carrier 410 has a second guide groove g2 and a fourth guide groove g4 in positions facing the first guide groove g1 and the third guide groove g3 formed in the first carrier 310, respectively. The second guide groove g2 and the fourth guide groove g4 may also be extended in a direction in parallel with the optical axis (Z-axis).

The first ball group B1 may be disposed between the first guide groove g1 and the second guide groove g2, and the second ball group B2 may be disposed between the third guide groove g3 and the fourth guide groove g4.

In a state in which the balls (spheres) included in the first ball group B1 and the second ball group B2 may be disposed in guide grooves formed in the first carrier 310 and the second carrier 410, the balls may move in a rolling motion in the optical axis direction (Z-axis).

One of the first ball group B1 and the second ball group B2 may serve as a main guide for guiding a movement of the first carrier 310 in the optical axis direction (Z-axis direction), and the other thereof may serve as an auxiliary guide for supporting the movement of the first carrier 310 in the optical axis direction (Z-axis direction).

For example, cross-sections of the first guide groove g1 and the second guide groove g2 are in a ‘v’ shape, and among the plurality of balls (spheres) forming the first ball group B1, two balls (spheres) disposed on an outermost side in at least the optical axis direction (the Z-axis direction) may be in two-point contact with the first guide groove g1 and the second guide groove g2, respectively. Accordingly, the first ball group B1 may serve as a main guide for guiding the movement of the first carrier 310 in the optical axis direction (Z-axis direction).

Meanwhile, a cross-section of the third guide groove g3 may be in a ‘—’ shape, a cross-section of the fourth guide groove g4 may be in a ‘v’ shape (and vice versa), and the plurality of balls (spheres) forming the second ball group B2 may be in one-point contact with the third guide groove g3 and may be in two-point contact with the fourth guide groove g4. Accordingly, the second ball group B2 may serve as an auxiliary guide for supporting the movement of the first carrier 310 in the optical axis direction (Z-axis direction).

As long as the first ball group B1 serves as the main guide and the second ball group B2 serves as the auxiliary guide, the second ball group B2 may include fewer balls (spheres) than the first ball group B1.

A first yoke 350 may be disposed in the second carrier 410. The first yoke 350 may be disposed on the other surface of the first substrate 611 (a surface opposite to one surface in which the first coil 333 and the first position sensor 335 are disposed).

The first yoke 350 may be disposed to face the first magnet 331 with the first coil 333 interposed therebetween, thereby preventing leakage of the magnetic flux.

Furthermore, the first yoke 350 may be formed of a magnetic material, thus generating attractive force with the first magnet 331. The first yoke 350 and the first magnet 331 may generate an attractive force in a direction facing each other, for example, a direction (Y-axis direction in the drawing) perpendicular to the optical axis.

The first ball group B1 and the second ball group B2 may maintain contact with the first carrier 310 and the second carrier 410 by the attractive force between the first yoke 350 and the first magnet 331.

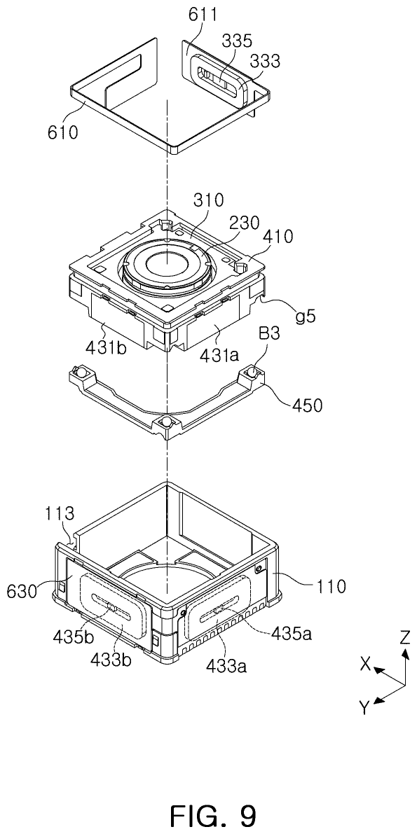

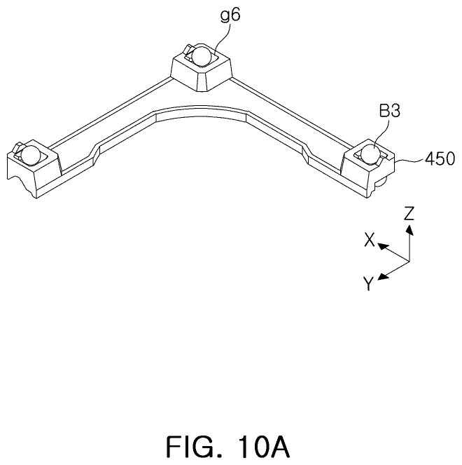

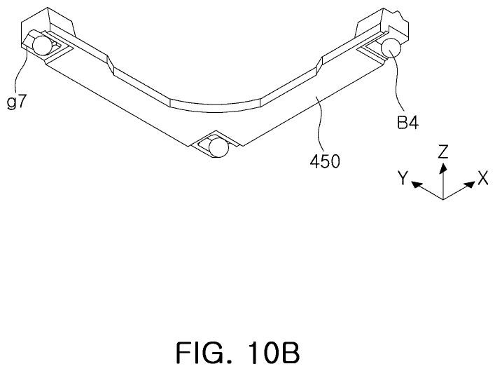

FIG. 9 is an exploded perspective view of a second carrier and a housing according to an example embodiment of the present disclosure, and FIGS. 10A and 10B are top and bottom perspective views of a ball guide according to an example embodiment of the present disclosure.

A shaking correcting unit 400 may include a second carrier 410 for accommodating a first carrier 310, and second and third drivers 430a and 430b for generating driving force for moving a second carrier 410 in directions (X-axis and Y-axis directions) perpendicular to the optical axis.

Referring to FIG. 9, like the housing 110, the second carrier 410 may be provided in a square box shape in which an upper portion and a lower portion thereof are open, and may have an internal space. The second carrier 410 may be accommodated in the internal space of the housing 110 while accommodating the first carrier 310 in the internal space.

Second and third drivers 430a and 430b may include second and third magnets 431a and 431b and second and third coils 433a and 433b.

The second and third magnets 431a and 431b and the second and third coils 433a and 433b may be separately disposed in the second carrier 410 and the housing 110. For example, the second and third magnets 431a and 431b may be disposed on two side surfaces of the second carrier 410, perpendicular to each other, and the second and third coils 433a and 433b may be disposed on two side surfaces of the housing 110 facing the two side surfaces of the second carrier 410, perpendicular to each other. Accordingly, the second and third magnets 431a and 431b and the second and third coils 433a and 433b may face each other in directions (X-axis and Y-axis directions) perpendicular to the optical axis, respectively.

A back yoke (not illustrated) may be disposed between the second and third magnets 431a and 431b and the second carrier 410. For example, the back yoke may be inserted into the second carrier 410 so that at least a portion thereof is exposed to two side surfaces of the second carrier 410, perpendicular to each other, in which the second and third magnets 431a and 431b are disposed. The back yoke may prevent leakage of magnetic flux by focusing the magnetic force of the second and third magnets 431a and 431b.

The second and third coils 433a and 433b may be disposed on two side surfaces of the housing 110, perpendicular to each other, while being mounted on a second substrate 630. The housing 110 may include openings 111 on two side surfaces in which the second substrate 630 is disposed, and the second and third coils 433a and 433b may directly face the second and third magnets 431a and 431b through the openings 111.

When power is applied to the second coil 433a, the electromagnetic force may be formed between the second magnet 431a and the second coil 433a, and the second carrier 410, the first carrier 310 and the lens unit 200 may be moved in a first axis direction (X-axis direction) perpendicular to the optical axis, by the electromagnetic force. Furthermore, when power is applied to the third coil 433b, electromagnetic force may be formed between the third magnet 431b and the third coil 433b, and the second carrier 410, the first carrier 310, and the lens unit 200 may be moved in a second axis direction (Y-axis direction) perpendicular to the optical axis, by the electromagnetic force.

In this case, the second and third magnets 431a and 431b disposed on the second carrier 410 may be moved in directions (X-axis and Y-axis directions) perpendicular to the optical axis, together with the second carrier 410. However, since the housing 110 is a fixed member, the second and third coils 433a and 433b disposed in the housing 110 may also be fixed members.

The second and third drivers 430a and 430b may include second and third position sensors 435a and 435b for sensing a position of the lens unit 200 in the directions (x-axis and y-axis directions) perpendicular to the optical axis. For example, the second and third position sensors 435a and 435b may be hall sensors, and the second position sensor 435a may sense the position of the lens unit 200 in the first axis direction (X-axis direction), and the third position sensor 435b may sense the position of the lens unit 200 in the second axis direction (Y-axis direction).

The second and third position sensors 435a and 435b may be mounted on the second substrate 630 together with the second and third coils 433a and 433b, and the second and third magnets 431a and 431b may face the second and third coils 433a and 433b in the directions (X-axis and Y-axis directions) perpendicular to the optical axis.

A plurality of ball members for guiding a movement of the second carrier 410 in the directions (X-axis and Y-axis directions) perpendicular to the optical axis, may be disposed between the second carrier 410 and the housing 110.

Referring to FIG. 9, a frame 450 may be disposed between the second carrier 410 and the housing 110. The frame 450 may have a ‘┐’ shape and may be disposed along edges of two side surfaces, perpendicular to each other, in which the second and third drivers 430a and 430b are disposed.

The plurality of ball members may be disposed between the second carrier 410 and the frame 450 and between the frame 450 and the housing 110, respectively.

The plurality of ball members may include a third ball group B3 and a fourth ball group B4 comprised of one or more balls (spheres), specifically, a plurality of balls (spheres) spaced apart from each other in the first or second axis direction (X-axis or Y-axis direction) on a plane perpendicular to the optical axis. The third ball group B3 and the fourth ball group B4 may include three balls (spheres). However, the number of balls (spheres) is not limited thereto, and three or more balls may be provided.

The third ball group B3 and the fourth ball group B4 may be spaced apart from each other in the optical axis direction (Z-axis direction). For example, the third ball group B3 may be disposed between the second carrier 410 and the frame 450, and the fourth ball group B4 may be disposed between the frame 450 and the housing 110.

The second carrier 410 and the frame 450 may include a fifth guide groove g5 and a sixth guide groove g6 extending in a direction in parallel with the first axis (X-axis), respectively, on surfaces facing each other in the optical axis direction (Z-axis direction).

Furthermore, the frame 450 and the housing 110 may include a seventh guide groove g7 and an eighth guide groove g8 extending in a direction in parallel with the second axis (Y-axis), respectively, on surfaces facing each other in the optical axis direction (Z-axis direction).

That is, as illustrated in FIGS. 10A and 10B, the sixth guide groove g6 may be provided on one surface (an upper surface) of the frame 450, and the seventh guide groove g7 may be provided on the other surface thereof (a lower surface). The sixth guide groove g6 and the seventh guide groove g7 may partially overlap each other in the optical axis direction (Z-axis direction).

The third ball group B3 may be disposed between the fifth guide groove g5 and the sixth guide groove g6, and the fourth ball group B4 may be disposed between the seventh guide groove g7 and the eighth guide groove g8.

In a state in which the balls (spheres) forming the third ball group B3 and the fourth ball group B4 are disposed in guide grooves formed in the second carrier 410 and the frame 450 or in the frame 450 and the housing 110, the balls may move in a rolling motion in the first or second axis direction (X-axis or Y-axis direction).

For example, the fifth guide groove g5 and the sixth guide groove g6 may extend in the direction in parallel with the first axis (X-axis), and the third ball group B3 may perform the rolling motion in the direction in parallel with the first axis (X-axis) while being disposed in the fifth guide groove g5 and the sixth guide groove g6. In this case, a movement in a direction in parallel with the second axis (Y-axis) may be restricted.

Similarly thereto, the seventh guide groove g7 and the eighth guide groove g8 may extend in the direction in parallel with the second axis (Y-axis), and the fourth ball group B4 may perform the rolling motion in the direction in parallel with the second axis (Y-axis) while being disposed in the seventh guide groove g7 and the eighth guide groove g8. In this case, a movement in the direction in parallel with the first axis (X-axis) may be restricted.

According to an example embodiment of the present disclosure, since a movement direction of the third ball member B3 and the fourth ball member B4 is limited to one of the first and second axis directions (X-axis and Y-axis directions), the lens unit 200 may be moved only in the first and second axis direction (X-axis or Y-axis direction) by driving force formed by the second and third drivers 430a and 430b, and may not be rotated with respect to the optical axis (Z-axis).

A pulling yoke (not illustrated) may be disposed in the housing 110. The pulling yoke may be disposed on a surface of the housing 110 oriented toward the frame 450.

A plurality of pulling yokes may be provided to face the second and third magnets 431a and 431b, respectively. The pulling yokes and the second and third magnets 431a and 431b may face each other in the optical axis direction (Z-axis direction). Since the pulling yokes are formed of a magnetic material, the pulling yokes may generate attractive force in a direction facing the second and third magnets 431a and 431b, that is, in the optical axis direction (Z-axis direction).

The third ball group B3 and the fourth ball group B4 may maintain contact with the second carrier 410, the frame 450, and the housing 110 by the attractive force between the pulling yokes and the second and third magnets 431a and 431b.

Second and third yokes 470a and 470b may be disposed in the housing 110. The second and third yokes 470a and 470b may be disposed on the other surface of the second substrate 630 (i.e., a surface opposite to one surface on which the second and third coils 433a and 433b and the second and third position sensors 435a and 435b are disposed).

The second and third yokes 470a and 470b may be disposed to face the second and third magnets 431a and 431b with the second and third coils 433a and 433b interposed therebetween, thereby preventing leakage of magnetic flux.

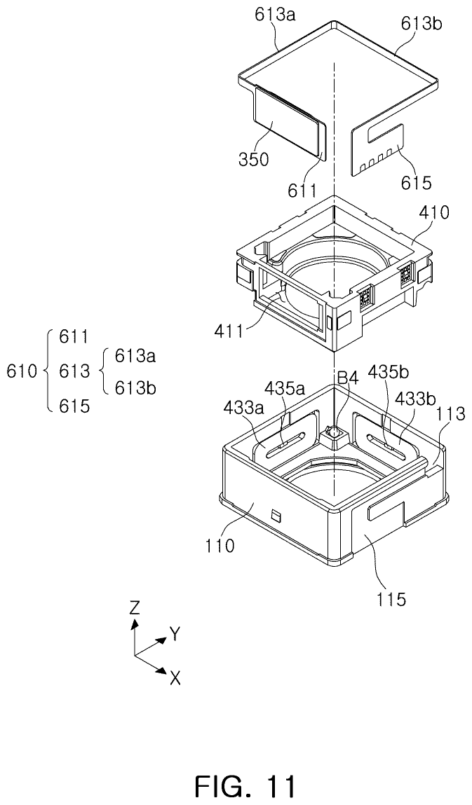

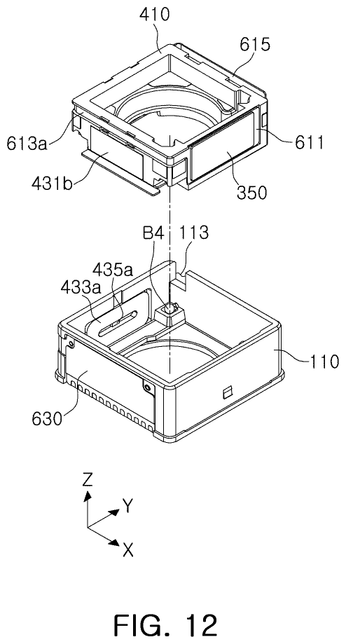

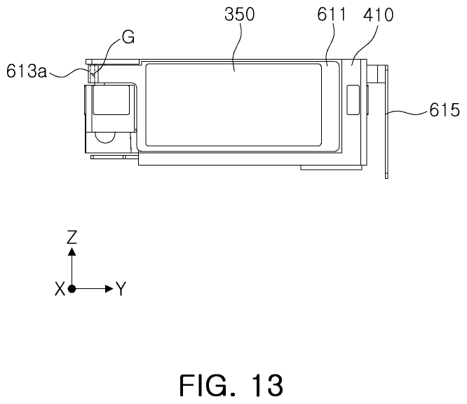

FIG. 11 is a perspective view illustrating a state in which a connection substrate is separated according to an example embodiment of the present disclosure, FIG. 12 is an exploded perspective view of a second carrier and a housing on which a connection substrate is mounted according to an example embodiment of the present disclosure, and FIG. 13 is a view of the second carrier of FIG. 12 when viewed from a different direction.

A camera module 1 according to an example embodiment of the present disclosure may include a connection substrate 610 for supporting a relative movement of a second carrier 410 with respect to a housing 110. To this end, at least a portion of the connection substrate 610 may be formed of a flexible material.

Referring to FIG. 11, the connection substrate 610 may include a portion (or a first substrate 611) disposed in a second carrier 410, a portion (or a connection portion 615) disposed in the housing 110, and a portion (or an extension portion 613) disposed between the second carrier 410 and the housing 110. The extension portion 613 may be a portion for connecting the first substrate 611 and the connection portion 615. In the following description of the extension portion 613, a first portion 613a may refer to a portion adjacent to the first substrate 611 of the extension portion 613, and a second portion 613b may refer to a portion adjacent to the connection portion 615.

The first substrate 611 may be disposed on one side surface of the second carrier 410 in which an opening 411 is formed in a state in which a first coil 333 is mounted. For example, the first substrate 611 may be formed integrally with the extension portion 613 and the connection portion 615, or may be formed separately from the extension portion 613 and the connection portion 615, and may then be coupled to the extension portion 613.

Since the first substrate 611 is disposed in the second carrier 410, the first substrate 611 may be moved in the directions (X-axis and Y-axis directions) perpendicular to the optical axis, together with the second carrier 410, and such a movement may be supported by the extension portion 613.

The extension portion 613 may be provided to surround some side surfaces of the second carrier 410. The extension portion 613 may be formed of a flexible material and may have a curved shape in a portion surrounding an edge of the second carrier 410.

The extension portion 613 may include a first portion 613a adjacent to the first substrate 611 and a second portion 613b adjacent to the connection portion 615. In an example embodiment of the present disclosure, since the second carrier 410 has a square box shape, the extension portion 613 may be provided to surround two side surfaces of the second carrier 410.

The first portion 613a may be disposed at a gap G from the other side surface, perpendicular to one side surface of the second carrier 410 in which the first substrate 611 is disposed. For example, the first portion 613a may be spaced apart from one side surface of the second carrier 410 and one side surface of the housing 110 facing the second carrier 410 in the second axis direction (Y-axis direction). The first portion 613a may be spaced apart from the second carrier 410 in the second axis direction (Y-axis direction) and may support a movement of the second carrier 410 in the second axis direction (Y-axis direction).

The second portion 613b may be disposed between the housing 110 and another side surface facing (in parallel with) one side surface of the second carrier 410 in which the first substrate 611 is disposed. That is, the second portion 613b may be spaced apart from another side surface of the second carrier 410 and one side surface of the housing 110 facing the second carrier 410 in the first axis direction (X-axis direction). The second portion 613b may be spaced apart from the second carrier 410 in the first axis direction (X-axis direction) to support a movement of the second carrier 410 in the first axis direction (X-axis direction).

Referring to FIG. 12, the housing 110 may include a through-hole 113 formed in an upper end of a side surface facing the second portion 613b in a longitudinal direction. The second portion 613b may be disposed to pass through the through-hole 113, and accordingly, the connection portion 615 may be disposed on an external side surface of the housing 110.

The housing 110 may include a settling groove 115 on an external side surface on which the connecting portion 615 is disposed, and the connecting portion 615 may be disposed in the settling groove 115.

The connection portion 615 may be disposed on the external side surface of the housing 110, and may receive electrical signals from the outside of the camera module 1.

Meanwhile, a connection substrate 610 may have a shape entirely surrounding four side surfaces of the second carrier 410 in one direction.

For example, the connection substrate 610 may be provided to surround the second carrier 410 toward the second ball group B2, among the first ball group B1 and the second ball group B2 disposed on both sides in the longitudinal direction with respect to the first magnet 331. In other words, in an example embodiment of the present disclosure, since the first ball group B1 is the main guide and the second ball group B2 is the auxiliary guide, the connection substrate 610 may be provided to surround the second carrier 410 toward the auxiliary guide. Accordingly, since a thickness of the second guide groove g2 formed in the second carrier 410 and accommodating the first ball member B1 is secured, a dent of the main guide may be reduced.

Meanwhile, the present disclosure may be modified and implemented as described below in relation to the above-described super macro function. In the following description of another example embodiment of the present disclosure, descriptions overlapping those of an example embodiment of the present disclosure may be omitted.

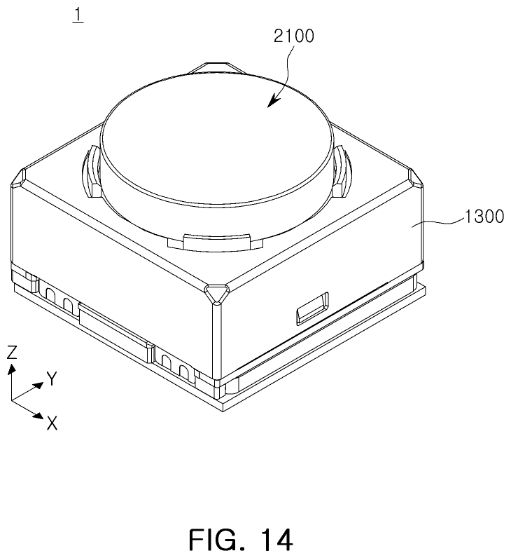

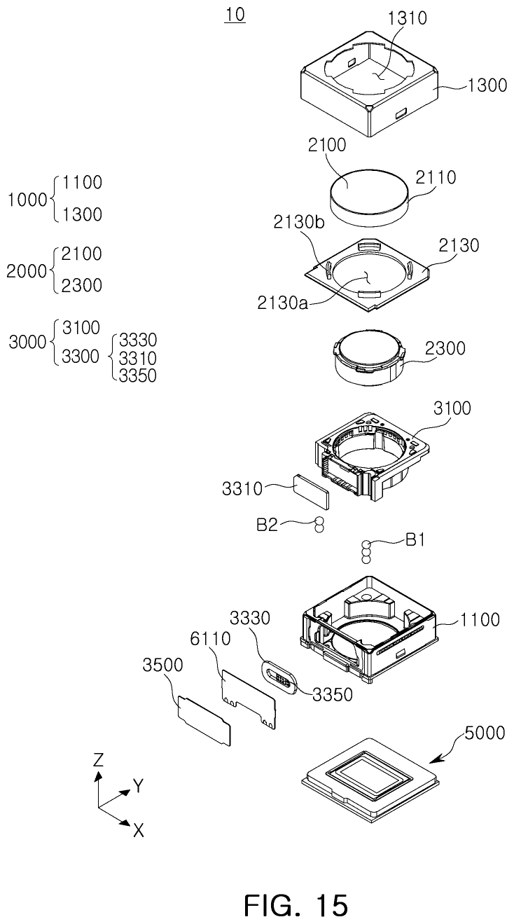

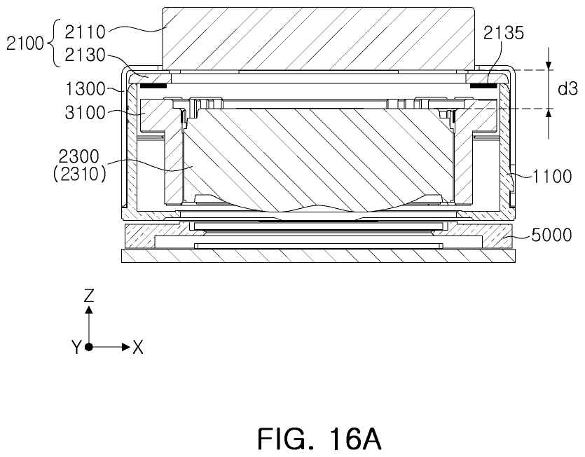

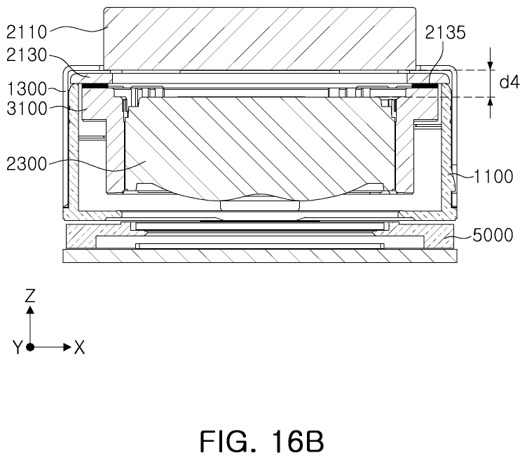

FIG. 14 is a perspective view of a camera module according to another example embodiment of the present disclosure, FIG. 15 is a schematic exploded perspective view of a camera module according to another example embodiment of the present disclosure, and FIGS. 16A and 16B are views illustrating examples of optical axis direction distances between a first lens unit and a second lens unit before and after autofocus adjustment.

Referring to FIGS. 14, 15, and 16, a camera module 10 according to another example embodiment of the present disclosure may include a housing unit 1000, a lens unit 2000, a focus adjustment unit 3000, and an image sensor unit 5000. That is, the camera module 10 according to another example embodiment of the present disclosure may not include a shaking correcting unit 400.

According to another example embodiment of the present disclosure, since the camera module 10 does not include the shaking correcting unit 400, the connection substrate 610 configured to support the movement of the second carrier 410 may also be omitted. Accordingly, a first substrate 6110 on which a first coil 3330 is mounted may be disposed on a side surface of a housing 1100.

The housing unit 1000 may include a housing 1100 having an internal space and a case 1300 coupled to the housing 1100 to cover the internal space.

The housing 1100 may be provided in the shape of a square box in which an upper portion and a lower portion thereof are open and may have the internal space, and the lens unit 2000 and the focus adjustment unit 3000 may be accommodated in the internal space. The image sensor unit 5000 may be coupled to a lower surface of the housing 1100.

More specifically, a portion of the lens unit 2000 may be accommodated in the internal space of the housing 1100, and another portion of the lens unit 2000 may protrude to the outside of the case 1300. The case 1300 may include an opening 1310 in which another portion of lens unit 2000 is disposed.

The lens unit 2000 may include a first lens unit 2100 and a second lens unit 2300 disposed in the optical axis direction (Z-axis direction). The first lens unit 2100 may be disposed in the opening 1310 of the case 1300, and the second lens unit 2300 may be accommodated in a first carrier 3100 of the focus adjustment unit 3000 and may be disposed in the internal space of the housing 1100.

The first lens unit 2100 and the second lens unit 2300 may include a first lens barrel 2110 and a second lens barrel 2310, respectively, and at least one lens may be mounted therein in the optical axis direction (Z-axis direction).

The first lens unit 2100 may further include a lens stage 2130 to which the first lens barrel 2110 is coupled.

The lens stage 2130 may have a square plate shape including an opening 2130a, and the first lens barrel 2110 may be disposed in the opening 2130a. Furthermore, the lens stage 2130 may include a guide protrusion 2130b protruding in the optical axis direction (Z-axis direction) along the circumference of the opening 2130a.

Furthermore, the lens stage 2130 may further include a buffer member 2135 on a lower surface thereof, and the buffer member 2135 may protrude toward the second lens unit 2300. The buffer member 2135 may serve to regulate a movement range of the first carrier 3100 in the optical axis direction (Z-axis direction) and alleviate impacts caused by collisions between components.

According to another example embodiment of the present disclosure, the second lens unit 2300 may be configured to relatively move with respect to the first lens unit 2100 in the optical axis direction (Z-axis direction). The second lens unit 2300 may be accommodated in the first carrier 3100 and moved in the optical axis direction (Z-axis direction) together with the first carrier 3100 during the focus adjustment. On the other hand, the first lens unit 2100 may be a fixing member coupled to the housing 1100.

The focus adjustment unit 3000 may include a first carrier 3100 for accommodating the second lens unit 2300 and a first driver 3300 for generating driving force to move the first carrier 3100 in the optical axis direction (Z-axis direction).

The first driver 3300 may include a first magnet 3310 and a first coil 3330.

The first driver 3300 may include a first position sensor 3350 for sensing a position of the lens unit 2000, specifically, the second lens unit 2300, in the optical axis direction (Z-axis direction). For example, the first position sensor 3350 may be a hall sensor.

A first yoke 3500 may be disposed in the housing 1100. The first yoke 3500 may be disposed on the other surface of the first substrate 6110 (a surface opposite to one surface in which the first coil 3330 and the first position sensor 3350 are disposed).

Accordingly, during the focus adjustment, distances d3 and d4 of the second lens unit 2300 with respect to the first lens unit 2100 in the optical axis direction (Z-axis direction) may be changed, thus implementing a super macro function.

As described above, according to the example embodiments of the present disclosure, since a weight of a portion moved in the optical axis direction (Z-axis direction) is reduced during focus adjustment, driving stability may be secured, and a focus adjustment function may be implemented with relatively little driving force. Accordingly, a macro function may be implemented by dividing a plurality of lenses into a first lens unit and a second lens unit and moving only a portion thereof in the optical axis direction (Z-axis direction). Furthermore, magnetic field interference from a shaking correcting driver that may occur during the focus adjustment may be avoided.

According to example embodiments of the present disclosure, correction performance of the camera module may be improved during capturing, and in particular, driving stability thereof may be ensured during a focus adjustment, thereby improving the correction performance during the capturing. Furthermore, a super macro function may be implemented even if the camera module has a short driving distance.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens unit comprising at least one lens;
a first carrier configured to accommodate a portion of the lens unit and move in an optical axis direction;
a second carrier configured to accommodate the first carrier and move in a direction perpendicular to the optical axis; and
a connection substrate disposed to surround a side surface of the second carrier,
wherein a first ball group and a second ball group spaced apart from each other in a direction perpendicular to the optical axis, are included between the first carrier and the second carrier,
wherein the number of balls of the first ball group is greater than the number of balls of the second ball group, and
wherein the connection substrate is disposed to surround the second carrier toward the second ball member.

2. The camera module of claim 1, further comprising:
a housing configured to accommodate the second carrier,
wherein the connection substrate comprises:
a first substrate disposed in the second carrier;
a connection portion disposed in the housing; and
an extension portion connecting the first substrate and the connection portion, and having a curved shape at a portion thereof.

3. The camera module of claim 2, wherein the extension portion comprises:
a first portion disposed between one side surface of the second carrier and a side surface of the housing facing the one side surface of the second carrier; and
a second portion disposed between the other side of the second carrier and a side of the housing facing the other side of the second carrier.

4. The camera module of claim 3, wherein the housing comprises a through-hole on a side surface on which the connection portion is disposed, and
wherein the second portion is disposed to pass through the through-hole.

5. The camera module of claim 2, further comprising:
a first magnet disposed on the first carrier between the first ball group and the second ball group; and
a first coil mounted on the first substrate and facing the first magnet,
wherein the first magnet and the first coil form driving force for moving the first carrier in the optical axis direction.

6. The camera module of claim 2, further comprising:
a second magnet and a third magnet disposed on two different side surfaces of the second carrier, respectively; and
a second coil and a third coil mounted on the second substrate and disposed in the housing so as to face the second and third magnets, respectively,
wherein the second and third magnets and the second coil and third coils form driving force for moving the second carrier in a direction perpendicular to the optical axis.

7. The camera module of claim 6, further comprising:
a frame disposed between the second carrier and the housing;
a third ball group disposed between the second carrier and the frame, and configured to move in a rolling motion in a first axis direction perpendicular to the optical axis; and
a fourth ball group disposed between the frame and the housing, and configured to move in a rolling motion in a second axis direction perpendicular to both the optical axis and the first axis.

8. The camera module of claim 1, wherein the first carrier and the second carrier comprise a plurality of guide grooves on surfaces facing each other with the first ball group and the second ball group interposed therebetween, and
wherein among the plurality of guide grooves, guide grooves facing each other with the second ball group interposed therebetween have different cross-sectional shapes.

9. The camera module of claim 1, wherein the lens unit comprises:
a first lens unit coupled to the second carrier; and
a second lens unit coupled to the first carrier and configured to move in the optical axis direction relative to the first lens unit.

10. The camera module of claim 9, wherein the first lens unit further comprises a lens stage fixedly coupled to an upper surface of the second carrier.

11. The camera module of claim 9, further comprising:
a stopper disposed between the first lens unit and the second lens unit.

12. A portable electronic device comprising:
the camera module of claim 1; and
an image sensor configured to convert light passing through the at least one lens into an electrical signal.

13. A camera module comprising:
a lens unit comprising a first lens unit and a second lens unit disposed in an optical axis direction;
a moving unit configured to accommodate the second lens unit and move in the optical axis direction, together with the second lens unit; and
a fixed unit configured to accommodate the moving unit and not to move in the optical axis direction,
wherein the first lens unit is coupled to the fixed unit and configured not to move in the optical axis direction.

14. The camera module of claim 13, wherein the moving unit comprises a first carrier, and the fixed unit comprises a second carrier, and
wherein the first lens unit is coupled to the second carrier, and is moved in a direction perpendicular to the optical axis, together with the second carrier, the first carrier, and the second lens unit.

15. The camera module of claim 14, further comprising:
a first magnet and a first coil configured to form driving force for moving the first carrier in the optical axis direction;
a second magnet and a second coil configured to form driving force for moving the second carrier in a first axis direction perpendicular to the optical axis; and
a third magnet and a third coil configured to form driving force for moving the second carrier in a second axis direction perpendicular to the optical axis and the first axis,
wherein the first coil is disposed in the second carrier, and the second and third coils are disposed in the housing.

16. The camera module of claim 15, further comprising:
a connection substrate connecting the second carrier and the housing,
wherein the connection substrate comprises:
a first substrate on which the first coil is disposed;
a connection portion disposed in the housing; and
an extension portion extending between the first substrate and the connection portion and configured to support a movement of the second carrier.

17. The camera module of claim 16, wherein the extension portion comprises:
a first portion supported by a side surface of the second carrier; and
a second portion spaced apart from the second carrier and the housing.

18. The camera module of claim 13, wherein the moving unit comprises a first carrier, and the fixed unit comprises a housing, and
wherein the first lens unit is coupled to the housing.

19. A portable electronic device comprising:
the camera module of claim 13; and
an image sensor configured to convert light passing through the first lens unit and the second lens unit into an electrical signal.
